(19) United States
(12) Patent Application Publication
(10) Pub. No.: US 2008/0207052 A1
(43) Pub. Date: Aug. 28, 2008

(54) Electrical Connector

(75) Inventor: Xue-Hai Zhang, Jiangsu (CN)

Correspondence Address: MOLEX INCORPORATED, 2222 WELLINGTON COURT, LISLE, IL, 60532, US

(73) Assignee: MOLEX INCORPORATED, Lisle, IL (US)

(21) Appl. No.: 11/665,870

(22) PCT Filed: Oct. 20, 2005
(86) PCT No.: PCT/US05/37905

§ 371 Date: Nov. 13, 2007

(30) Foreign Application Priority Data
Oct. 22, 2004 (CN) 200420117631.3

(51) Int. Cl. H01R 13/648

(52) U.S. Cl. 439/607

(57) ABSTRACT

An electrical connector includes a shielding cover, a dielectric housing and a plurality of conductive terminals. The shielding cover includes two pairs of bending and transition portions of the shielding cover in an identical configuration with a symmetric structure, so that the shielding cover is easily manufactured. Furthermore, the dielectric housing includes two support portion to support the bending and transition portions of the shielding cover from below, to prevent the bending and transition portions from being deformed during repeated insertion with an withdrawn from a mating connector.

### FIELD OF THE INVENTION

The present invention relates to an electrical connector, and more particularly to an electrical connector, which is easily manufactured, and which has additional structure to support the bending and transition portions of the shielding cover of the electrical connector.

### BACKGROUND OF THE INVENTION

Electrical connectors are widely applied for electrically connecting electrical components for facilitating assembly and disassembly between the electrical components. Different requirements correspond to electrical connectors with different functions. Regarding an electrical connector for high frequency and high-speed signal transmission, the energy of electromagnetism radiation is largely increased due to the increasing of working frequency, it is important to shield electromagnetism interference produced by the signal transmission, and the electrical connector is often provided with a shielding cover for shielding electromagnetism interference.

Referring to FIG. 5, a prior art electrical connector, includes a shielding cover 100, a dielectric housing 200 fitted in the shielding cover 100, and a plurality of conductive terminals 300 inserted in the dielectric housing 200. The shielding cover 100 includes a top wall 102, two side walls 104 bending downward from the top wall 102 and two bottom walls 106. The two side walls 104 of the shielding cover 100 are bent downward to form two pairs of bending and transition portions 108, 110 having different configurations, wherein the rear bending and transition portions 110 are formed by substantively vertical bending, while the front bending and transition portions 108 are formed by slantedly bending a certain angle.

However, the two pairs of bending and transition portions 108, 110 of the shielding cover 100 of the prior art electrical connector are in different configurations. Such an unsymmetric structure causes relative difficulty and inconvenience for manufacturing a punch model and processing the electrical connector. Additionally, the front bending and transition portions 108 are suspended and are not supported by a support member, thereby they are easily deformed after repeated insertion with and withdrawal from a mating connector.

### SUMMARY OF THE INVENTION

Accordingly, an object of the present invention is to provide an electrical connector, two pairs of bending and transition portions of a shielding cover thereof are easily manufactured due to being adopted with a symmetric structure having an identical configuration.

Another object of the present invention is to provide an electrical connector, two sides of a dielectric housing thereof are additionally provided with two support portions for supporting the bending and transition portions, so that the bending and transition portions are not easily deformed after repeated insertion and withdrawal.

To fulfill the above-mentioned objects, an electrical connector of the present invention includes a shielding cover, a dielectric housing and a plurality of conductive terminals. The shielding cover includes a top wall, two sidewalls bending downward from two sides of the top wall respectively, and a bottom wall further bending from each of the two sidewalls of the shielding cover. The dielectric housing includes a vertical wall, and a bottom plate extending outwardly from the vertical wall in a direction toward a mating connector. The bottom plate has at least one support portion projecting upwardly from a side of the bottom plate. The shielding cover also includes at least one pair of bending and transition portions in an identical configuration formed between one of the two sidewalls and the bottom wall of the shielding cover. The support portion of the dielectric housing is located directly below the bending and transition portions to prevent the bending and transition portions from being deformed. Other features are optionally included on the electrical connector of the present invention.

The electrical connector of the present invention adopts two pairs of bending and transition portions of the shielding cover in an identical configuration with a symmetric structure, so that the shielding cover is easily manufactured. Furthermore, the two support portions of the dielectric housing support the bending and transition portions of the shielding cover from the below, to thereby prevent the bending and transition portions from being deformed as a result of repeated insertion and withdrawal with a mating connector.

### DESCRIPTION OF THE DRAWINGS

The organization and manner of the structure and operation of the invention, together with further objects and advantages thereof, may best be understood by reference to the following description, taken in connection with the accompanying drawings, wherein like reference numerals identify like elements in which:

FIG. l is an exploded perspective view of an electrical connector of the present invention;

FIG. 2 is an exploded perspective view of a shielding cover and a dielectric housing of an electrical connector of the present invention;

FIG. 3 is an assembled view of FIG. 1;

FIG. 4 is a perspective view of an electrical connector of the present invention and a corresponding electrical connector; and

FIG. 5 is an exploded perspective view of a prior art electrical connector.

### DETAILED DESCRIPTION OF THE DISCLOSED EMBODIMENT

While the invention may be susceptible to embodiment in different forms, there is shown in the drawings, and herein will be described in detail, a specific embodiment with the understanding that the present disclosure is to be considered an exemplification of the principles of the invention, and is not intended to limit the invention to that as illustrated and described herein.

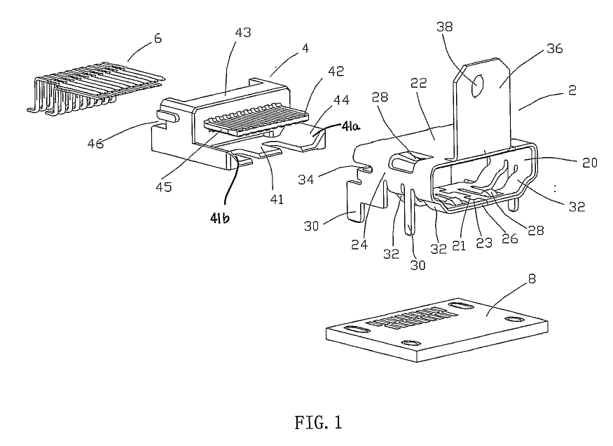

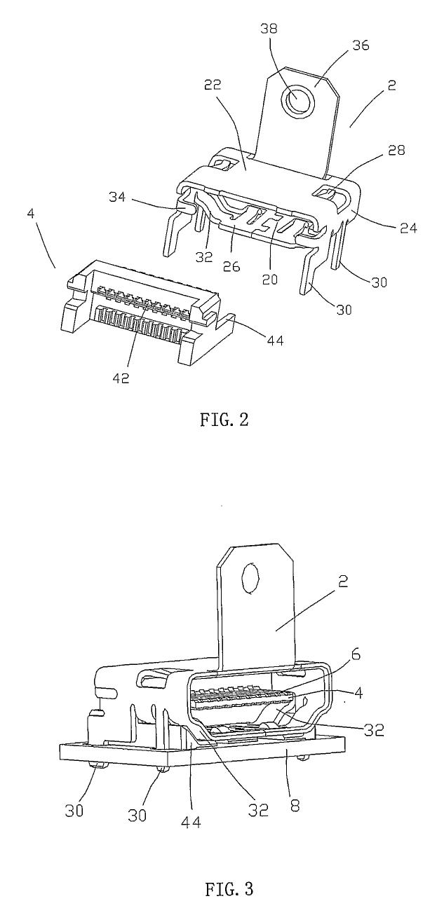

Referring to FIGS. 1 to 4, an electrical connector of the present invention may be used for an interface of a high definition multimedia, which includes a shielding cover 2, a dielectric housing 4 and a plurality of conductive terminals 6.

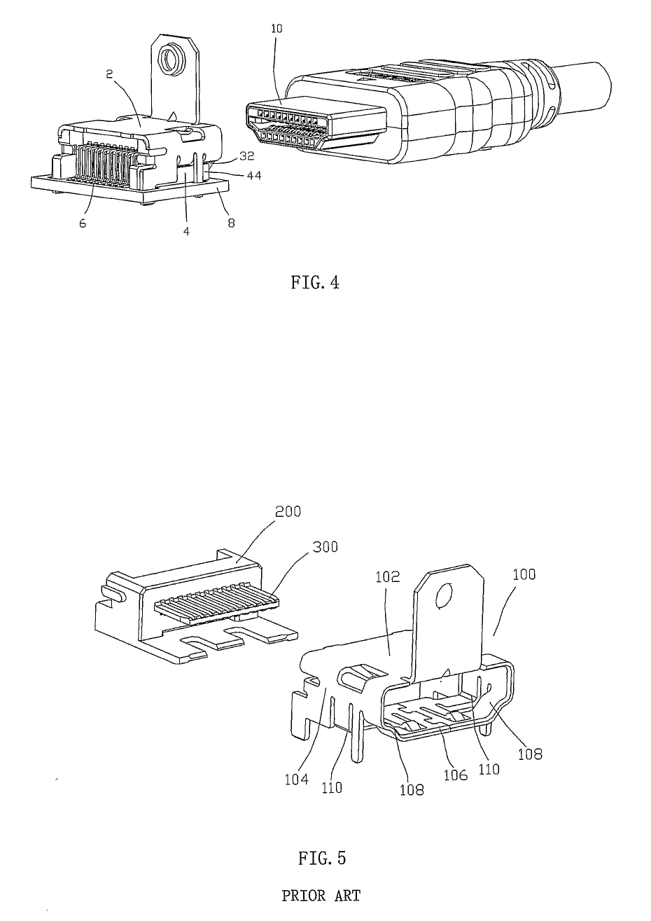

The shielding cover 2 is integrally formed by punching and bending from a metal piece, and is formed with a chamber 20, which includes a top wall 22, two side walls 24 bending downward from two sides of the top wall 22 respectively, and a bottom walls 26 further bending from each of the two side walls 24 of the shielding cover 2. A plurality of projected latches 21 and a plurality of corresponding recessed latches 23 are formed at ends of the two bottom walls 26 respectively, these recessed latches 23 and projected latches 21 are correspondingly latched to prevent the two bottom walls 26 from sliding forward and backward with respect to each other. The top wall 22 and the bottom walls 26 of the shielding cover 2 are formed with two latching claws 28, respectively, the latching claws 28 may correspondingly latch with a corresponding mating electrical connector 10 (see FIG. 4), thereby obtaining a steady engagement. The sidewalls 24 of the shielding cover 2 extend downward with two pairs of joint legs 30 to be correspondingly soldered to a circuit board 8. Wherein two pairs of bending and transition portions 32 in an identical configuration and in a symmetric structure are formed on each of the two side walls 24 and extends to the bottom walls 26 of the shielding cover 2. A latching arm 34 extends backward from each of the two sidewalls 24 of the shielding cover 2 (note: the shape of the latching arms 34 shown in the drawings is the shape it forms after being bent after insertion of the dielectric housing 4). A front end of the top wall 22 of the shielding cover 2 extends upward to form a fixing plate 36, and a fixing hole 38 is defined in the fixing plate 36.

The dielectric housing 4 includes a vertical wall 43, a bottom plate 41 extending forward from the vertical wall 43, and a separate terminal locating plate 45 extending forward from a middle portion of the vertical wall 43 and spaced apart from and generally parallel to the bottom plate 41. The separate plate 45 may be received in the chamber 20 of the shielding cover 2, and the upper and lower surfaces of the separate plate 45 define a plurality of receiving slots 42 for receiving the conductive terminals 6. Two sides 41 a, 41b of the bottom plate 41 of the dielectric housing 4 project upward with two support portions 44 in shapes corresponding to the bending and transition portions 32, and the two support portions 44 each may be inserted between the joint leg 30 and the bending and transition portion 32 of the shielding cover 2, for supporting the bending and transition portion 32 from below to prevent it from being deformed. Two sides of the vertical wall 43 of the dielectric housing 2 further define a latching slot 46, respectively, and the latching arms 34 of the shielding cover 2 may be latched with corresponding latching slots 46 of the vertical wall 43 for fixing the dielectric housing 4 to the shielding cover 2.

During assembly, the conductive terminals 6 are firstly inserted into corresponding receiving slots 42 of the dielectric housing 4, then the dielectric housing 4 is mounted on the shielding cover 2, so that the two support portions 44 thereof support the bending and transition portions 32 of the shielding cover 2 from below, thereby preventing the bending and transition portions 32 from being deformed. Finally the latching arms 34 of the shielding cover 2 are punched and bent, so that they are assembled with the latching slots 46 of the vertical wall 43 for fixing the dielectric housing 4 to the shielding cover 2.

Because the two pairs of bending and transition portions 32 of the shielding cover 2 are identical, they can be formed in a single bending operation as compared to the prior art shielding cover that required two bending operations to form the two different pairs of bending and transition portions 108 and 110. Furthermore, the bending and transition portions 32 are protected from being deformed after repeated insertions and withdrawals due to the two support portions 44 of the dielectric housing 4 supporting the bending and transition portions 32 from the below.

While a preferred embodiment of the present invention is shown and described, it is envisioned that those skilled in the art may devise various modifications of the present invention without departing from the spirit and scope of the appended claims.

What is claimed is:

1. An electrical connector, comprising:
a shielding cover;
a dielectric housing; and
a plurality of conductive terminals, the conductive terminals being mounting in the dielectric housing,
wherein the dielectric housing includes a vertical wall and a bottom plate extending outwardly from the vertical wall in a direction toward a mating connector, the bottom plate having at least one support portion projecting upwardly from a side of the bottom plate;
wherein the shielding cover includes a top wall, two side walls respectively bending downward from two sides of the top wall, and a bottom wall further bending from each of the two side walls of the shielding cover, the shielding cover further having at least one pair of bending and transition portions in an identical configuration formed between one of the two side walls and the bottom wall of the shielding cover, and wherein the support portion of the dielectric housing is located directly below the bending and transition portions to prevent the bending and transition portions from being deformed.

2. The electrical connector as claimed in claim 1, wherein the dielectric housing includes a separate plate extending from the vertical wall in the same direction as the bottom plate, and wherein the separate plate is spaced apart from the bottom wall.

3. The electrical connector as claimed in claim 2, wherein the separate plate and the bottom plate are generally parallel to each other.

4. The electrical connector as claimed in claim 2, wherein the conductive terminals are mounted on the separate plate.

5. The electrical connector as claimed in claim 1, wherein the shielding cover is formed by punching and bending a single piece of metal.

6. The electrical connector as claimed in claim 1, wherein the dielectric housing includes a pair of support portions, each support portion projecting upwardly from one side of the bottom plate, wherein the shielding cover includes two pairs of bending and transition portions of identical configuration, one pair formed between one of the side walls and the bottom wall of the shielding cover and the other pair formed between the other side wall and the bottom wall, and wherein the support portions are respectively located under a respective pair of bending and transition portions.

7. The electrical connector as claimed in claim 1, wherein the bottom wall is in two bottom wall sections, the bottom wall sections respectively form a plurality of projected latches and a plurality of corresponding recessed latches, these recessed latches and projected latches are correspondingly latched with each other to prevent the two bottom walls from sliding forward and backward.

8. The electrical connector as claimed in claim 1, wherein two latching claws are formed on the top wall and the bottom walls of the shielding cover, respectively.

9. The electrical connector as claimed in claim 2, wherein the shielding cover encloses to form a chamber, and the separate plate is received in the chamber.

10. The electrical connector as claimed in claim 1, wherein each of the sidewalls includes at least one downwardly extending joint leg.

11. The electrical connector as claimed in claim 10, wherein the two support portions are inserted between the joint leg and the corresponding bending and transition portions of the shielding cover, respectively.

12. The electrical connector as claimed in claim 2, wherein the two sides of the separate plate define a plurality of receiving slots for receiving the conductive terminals, respectively.

13. The electrical connector as claimed in claim 1, wherein each side of the vertical wall of the dielectric housing defines a latching slot, respectively.

14. The electrical connector as claimed in claim 13, wherein the two sidewalls of the shielding cover respectively extend backward with a latching arm, and the latching arm after being bent may be assembled with the latching slot of the vertical wall to fix the dielectric housing to the shielding cover.

15. The electrical connector as claimed in claim 1, wherein a front end of the top wall of the shielding cover further extends upward with a fixing plate, and a fixing hole is defined in the fixing plate.

16. The electrical connector as claimed in claim 10, wherein the joint leg extending from the sidewall is located between the two bending and transition portions located on the same sidewall.
